(19) United States
(12) Patent Application Publication
(10) Pub. No.: US 2010/0218407 A1
(43) Pub. Date: Sep. 2, 2010

(54) SIGN CONTAINING FOOD NUTRITION INFORMATION FOR GROCERY SHOPPERS

(76) Inventor: Gredo Woong Kahng, Houston, TX (US)

Correspondence Address: Kenneth Bower, 314 Ironstone Lane, Elverson, PA, 19520, US

(21) Appl. No.: 12/715,647

(22) Filed: Mar. 2, 2010

Related U.S. Application Data
(60) Provisional application No. 61/156,747, filed on Mar. 2, 2009.

(51) Int. Cl. G09F 7/00

(52) U.S. Cl. 40/584

(57) ABSTRACT

Disclosed is printed matter for display in the proximity of food items at the grocery store that associates the printed information with the food product by use of a printed photograph of the food product and name of the food product. It also relates the benefits and efficacy of consuming the food product and its components to the consumers age, physical condition and/or gender, in words, symbols or characterizations of people and color coding of the media. It also highlights the beneficial components of the food product without the need for reading the small print on product labels. The present invention aids a grocery shopper to easily acquire and understand the efficacy and component information of the food product on the grocery store shelf.

### CROSS-REFERENCE TO RELATED APPLICATIONS

This application hereby claims priority to provisional application No. 61/156,747, filed Mar. 2, 2009

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The present invention represents a large step forward in the field of food product advertising displayed with the food product at the grocery store. It promotes purchase by relating the efficacy and component of the food product to the particular age group, physical condition or gender of the persons who will ultimately consume the food product. The preferred embodiment of the present invention relates all of this information to a grocery shopper at a glance to be effective through the use of photography, relating efficacy and component of the food product to the age, physical condition and gender of the consumer in succinct outline form and summarizing the nutritional components as well. The present invention also highlights the information that may have a positive effect on the ultimate consumer based on age, physical condition and/or gender and conveys additional information by use of characterization of people that may also be color coded and/or through information based color coding of the printed media.

### PRIOR ART

The following disclosures are found in the art of record.

The published patent application to Bateman (US2004/0023189) discloses a system and method for displaying nutritional information having a food product illustration and a partial or completely color coded background indicating the nutritional value of the food product. However Bateman lacks a food product photograph, lacks a printed name of the food product, also lacks efficacy and component of the food product related to the age, physical condition or gender of the ultimate consumer, and finally lacks characterizations of people according to age, physical condition or gender and color coding of the background.

The patent to Frankhauser (US Des. 323,680) discloses a sign for communicating food product information relating to leftovers that is divided into three sections vertically with pictures or illustrations in the top section, a list of leftovers names in the center section. Frankhauser, however, lacks displaying nutritional information, lacks having a color coded background indicating the nutritional value of the food product. Bateman also lacks a food product photograph and also lacks efficacy and component of the food product related to the age, physical condition or gender of the ultimate consumer, and finally lacks characterizations of people according to age, physical condition or gender and color coding of the background.

The published patent application to Gordon (US 2006/0263750) discloses printed matter communicating the nutritional value of a food product. However, Gordon lacks a food product photograph and printed name of the food product, also lacking is the efficacy and component of the food product related to the age, physical condition or gender of the ultimate consumer, there also are no characterizations of people according to age, physical condition or gender, nor does Gordon disclose color coding of the printed media and a listing of beneficial nutritional components.

### BRIEF SUMMARY OF THE INVENTION

The present invention is a sign that is designed to assist a grocery store customer in the selection of food products that are healthy for themselves and the members of their family. It clearly associates the nutritional efficacy and component information with the correct food product with a picture of the food product and the food product name at the top. The benefits or efficacy of the food product is then stated in summary outline format, followed by specific benefits for consumers that are members of specific age groups, physical conditions such as pregnancy and/or gender. The shoppers attention is directed to specific statements of efficacy by the presence of characterizations of people in specific age groups, physical conditions such as pregnancy and/or gender next to the corresponding statements of interest. These statements are in outline form and are followed by a list of the primary components of the food product at the bottom of the sign. Further information regarding the properties, benefits, efficacy and component of the food product can be communicated by color coding of the characterizations or coloring of the media.

### BRIEF DESCRIPTION OF THE SEVERAL VIEWS OF THE DRAWING(S)

FIG. 1: Is a plan view of the preferred embodiment of the present invention.

FIG. 2: Is a front view of the preferred embodiment of the present invention on display.

### DETAILED DESCRIPTION OF THE INVENTION

Poor nutrition is rapidly becoming one of the major health problems in the civilized world affecting all people including babies, children, teenagers, men, women, pregnant women and seniors. Proper nutrition is one of the leading defenses against this insidious problem. There are many sources for nutritional information available to the public including, books, news papers and the Internet. However, few shoppers carry such nutritional information with them when they shop in the grocery store. The present invention is a sign that summarizes nutritional information that is displayed in proximity of a food product, making it convenient for the consumer to make wise dietary choices in the grocery store.

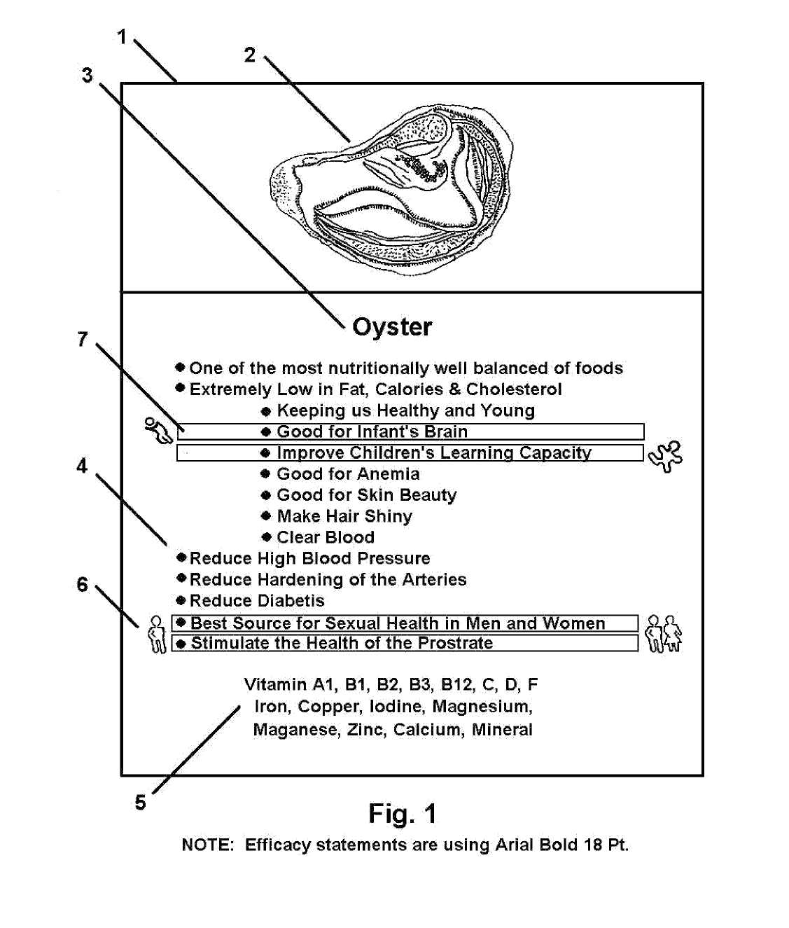

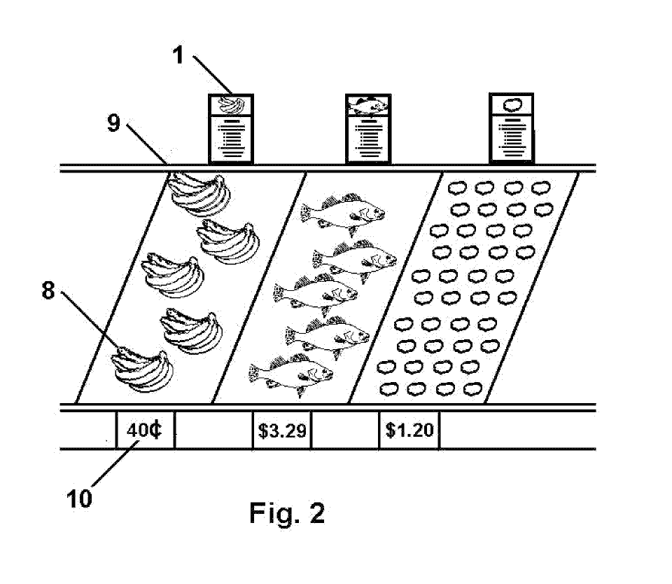

Referring to FIGS. 1 and 2, there is a picture or illustration 2 of the food at the top of the sign 1 in the preferred embodiment of the present invention. The picture 2 eliminates any confusion regarding which of a number of foods on display is referred to by the sign 1. For purposes of illustration the sign 1 is shown as a flat, rectangular surface.

However, the sign 1 may include but is not limited to one or more flat or three dimensional surfaces with regular, irregular, ornamental, branded, symbolic or simulative outlines. The sign 1 surface may also be an electronically controlled or addressed device such as a television set, computer monitor or an array of lights that forms letters and numbers by turning certain lights on or off. The sign that summarizes nutritional information is then displayed FIG. 2 in proximity of a food product 8 making it convenient for the consumer to make wise dietary choices. The picture 2 is shown as an example of a single unpackaged product that is typically displayed on ice. However, the product picture 2 may also include but is not limited to a real sample of the product, two or three dimension model of the product, electronic representation either selectively radiating as in a LCD or Plasma display or reflecting the image off of the surface as with a projector. The product picture 2 may also include but is not limited to multiple or a bunch of products, packaged or partially packaged products or any other means of associating the sign 1 with the food product 8.

Food 8 display environments 9 are often hostile to signs 1. Frequent cleanings, timed water sprays, spills, bumping and jostling are among the many hazards that can affect the appearance or content of a sign 1 in this environment. Any means of protecting the sign 1 either by but not limited to selection of media and print media, coatings, coverings or attachments are considered to be within the spirit of the instant invention.

Referring again to FIG. 1, the name 3 of the product is shown in a prominent place on the sign of the preferred embodiment of the present invention. Prominence in the sign 1 illustration is established by location directly below the picture 2. However, the name 3 may gain prominence by the size, color, font, location or plane in which the name 3 is written.

The efficacy 4, of the food in the preferred embodiment of the present invention is located in the lower center of the sign 1 and is shown for illustration purposes in bulleted outline form. Efficacy 4 however, may be communicated in one or more of and is not limited to a graph, color background 7, color codes, symbols 6, and may be written in English or any different foreign language for use worldwide or any combination thereof. The example of symbols 6 as shown in FIG. 1 are clip art but can be taken from any source what so ever.

The components of the food product 5 are located at the bottom of the sign 1 of the preferred embodiment of the present invention with the vitamins in alphabetical order and the minerals in random order.

Symbols 6 make it easy to find food products 8 having a specific efficacy 4 and component to fulfill the shoppers dietary needs based on shoppers age of gender. For instance the symbols 6 can be shaped to indicate that the efficacy 4 and component is suggested for a baby, child, teenager, pregnant woman, senior, woman or man.

In addition to the symbols 6 another way of assisting the shopper to find foods with a specific efficacy 4 is with the color of the background 7, corresponding to foods with a specific efficacy 4 that the shopper may be looking for.

Referring to FIG. 2, the sign 1 is shown posted at the top of display 9 but may be located anywhere around the perimeter of the display or within the display itself or on a wall or other surface in the proximity of the display 9 or suspended above the display 9. A possible location of the food product 8 and pricing information 10 is also shown in FIG. 2. Alternative locations and arrangement of the food are considered to be within the spirit of the present invention.

I claim:

1. A communication of product information, comprising:
a media for carrying product information;
one visible representation of the product for associating the sign with a displayed product at a grocery store;
a name of the product;
one or more data about the product;
wherein the product information is written one or more languages taken from the list: i. English, ii. a language foreign to English, iii. a combination of English and languages foreign to English, iv. a combination of languages foreign to English.

2. The communication of claim 1, wherein:
the data consists of the efficacy and component of the product.

3. The communication of claim 1, wherein:
the visible representation of the product is a picture.

4. The communication of claim 2, wherein:
the visible representation of the product is a picture.

5. The communication of claim 1, wherein:
the media for carrying product information is taken from the list: i. a sign, ii. a sticker, iii. a poster, iv. a brochure, v. a flyers, vi. an electric device, vii. a website, viii. a receipt, ix. a shopping bag, x. a food nutrition book;
the media for carrying product information is distributed by a grocery company.

6. The communication of claim 2, wherein:
the media for carrying product information is taken from the list: i. a sign, ii. a sticker, iii. a poster, iv. a brochure, v. a flyer, vi. an electric device, vii. a website, viii. a receipt, ix. a shopping bag, x. a food nutrition book;
the media for carrying product information is distributed by a grocery company.

7. The communication of claim 1, wherein:
the media includes but is not limited to a color background;
the data includes but is not limited to a graph, color codes, symbols or any combination thereof.

8. The communication of claim 2, wherein:
the media includes but is not limited to a color background;
the data includes but is not limited to a graph, color codes, symbols or any combination thereof.

9. A stationary grocery display marker comprising:
a media;
a photograph of a food item printed on the media,
wherein the photograph is printed on the top, middle or bottom area of the media;
at least one name for the food item printed on the media;
at least one efficacy statement printed on the media describing at least one benefit of eating the food item;
at least one component of the food item printed on the media;
wherein the stationary grocery display marker is attached to a display containing a supply of the food item for purchase;
at least one characterization of a person printed on the media.

10. The stationary grocery display marker of claim 9, wherein:
the media for carrying product information is taken from the list: i. a sign, ii. a sticker, iii. a poster, iv. a brochure, v. a flyer, vi. an electric device, vii. a website, viii. a receipt, ix. a shopping bag, x. a food nutrition book;
the media for carrying product information is distributed by a grocery company.

11. The stationary grocery display marker of claim 9, wherein:
the at least one characterization of a person symbolizing the age and or gender of a suggested consumer of the food item.

12. The stationary grocery display marker of claim 11, wherein:
the at least one characterization of a person is printed on the media oriented in a direct horizontal line with the beginning or end of the at least one efficacy statement.

13. The stationary grocery display marker of claim 12, wherein:
all or part of the media is color coded to indicate a second benefit or a second cause or a second effect of eating the food item.

14. The stationary grocery display marker of claim 13, wherein:
the at least one name is printed on the media directly below or on the right or the left side of the photograph.

15. The stationary grocery display marker of claim 14, wherein:
the at least one efficacy statement is printed directly below or on the right or the left side of the at least one name.

16. The stationary grocery display marker of claim 14, wherein:
the one or more efficacy statements includes but are not limited to a graph, a symbol or any combination thereof.

17. The stationary grocery display marker of claim 9, wherein:
the at least one characterization of a person is printed in monochrome color;
at least a part of the media area is color coded to indicate a second benefit or a second cause or a second effect of eating the food item;
the at least one component is printed directly below the at least one efficacy statement;
the at least one component is printed at a bottom most area of the media;
the at least one name is printed on the media directly below the photograph;
the at least one efficacy statement is printed directly below the at least one name;
the one or more efficacy statements may include but are not limited to a graph, a symbol or any combination thereof.

18. A media for carrying a food product information:
a printed media;
a printed information on the media that describes a component of the food product;
wherein the printed information is in an outline form.

19. The media for carrying a food product information of claim 18 wherein:
the at least one food product component is printed directly below or on the right or left side of the at least one efficacy statement;
the component of the food product are located at the bottom or side of the sign of the preferred embodiment of the present invention with the vitamins in alphabetical order and the minerals in random order.

20. The media for carrying a food product information of claim 18, wherein:
the media for carrying product information is taken from the list: i. a sign, ii. a sticker, iii. a poster, iv. a brochure, v. a flyer, vi. an electric device, vii. a website, viii. a receipt, ix. a shopping bag, x. a food nutrition book;
the media for carrying product information is distributed by a grocery company.
